(19) United States
(12) Patent Application Publication
(10) Pub. No.: US 2007/0051774 A1
(43) Pub. Date: Mar. 8, 2007

(54) Method of controlling solder deposition on heat spreader used for semiconductor package

(76) Inventors: John N. Stipp, Alsip, IL (US); Brian T. Deram, Lincolnshire, IL (US)

Correspondence Address: RYNDAK & SURI LLP, 200 W. MADISON STREET, SUITE 2100, CHICAGO, IL, 60606, US

(21) Appl. No.: 11/220,457

(22) Filed: Sep. 6, 2005

(51) Int. Cl. A47J 36/02

(52) U.S. Cl. 228/101

(57) ABSTRACT

Method for controlling the deposition of solder on a heat spreader or heat sink is disclosed. The method comprises applying an attaching flux and finishing flux to a heat spreader, placing a preform thereon and subjecting the same to reflow conditions. The finishing flux is applied to solubilize the normally insoluble corrosive residues that would occur when the attaching flux is subjected to reflow conditions with the preform and heat spreader. Alternatively, the attaching flux may be applied to the preform and heat spreader before undergoing reverse reflow conditions and then the finishing flux is applied to the solder deposit and heat spreader and the same subjected to second reflow conditions. After each method, the residues left from the attaching flux which are solubilized by the finishing flux, are cleaned by washing with a typical solvent. The solder deposit can be optionally flattened before coupling with a die. Further, an attach flux may also be applied on the solder deposit on the heat spreader to assist in the coupling to the die or heat sink.

### BACKGROUND OF THE INVENTION

1. Field of the Invention

The present invention relates to a method of predepositing a specific amount of solder metal to a perform and heat spreader or heat sink thereby facilitating the removal of heat from the semiconductor or other element the heat spreader is attached to. More particularly, the present invention relates to a method of forming a solder deposit having desired dimensions of the final deposit directly on the heat spreader by reflowing the perform by use of an aggressive flux and preferably an application of a finishing flux. The deposit is preferably flattened or coined for an improved attachment to the semiconductor and coated with an additional attach flux.

2. Description of the Prior Art

This method is an improvement over the method described in the co-inventors' U.S. Pat. No. 6,786,391, incorporated herein by reference.

When soldering to a metal surface, whether the purpose for soldering is to create electrical connections or non-electrical, mechanical connections, the solder must metalize, or bond to, the metal surface. Good electrical or thermal conduction by the solder is dependent on void-free solder bonding to the metal surface. An example in the electronics assembly industry is to solder a metallic lid or cover onto an electronic device that must be cooled. The heat conducting lid can then radiate heat or transfer it to a thermal pipe for removing the heat, thereby cooling the device. The soldering flux must be selected for its ability to remove contamination, mostly oxides, from the metal surface so the melted solder can properly bond to the metal.

The vast number of soldering fluxes can be placed into groupings or categories by the corrosive nature of their residues as is done in IPC/EIA Standard J-STD-004 “Requirements for Soldering Fluxes”. This industry document classifies fluxes according to their basic composition and percent halides included in the composition. Another industry standard is ASTM B 32 “Standard Specification for Solder Metals” that includes a similar grouping of flux types. Additionally, another international standard is ISO 9454 “Soft Soldering Fluxes-Classification and Requirements” that delineates the performance requirements for fluxes classified by ingredients. There may be flux choices not specifically covered by these standards, but generally the fluxes can be categorized by composition into three groups and defined as:
Inorganic Flux—A solution of inorganic acids and/or salts, including, but not limited to, halide salts of metals, such as zinc chloride, zinc bromide, stannous chloride, stannous bromide, stannous fluoride, sodium chloride, in water and optionally containing ammonium chloride, mineral acids, such as hydrochloric acid, hydrobromic acid, phosphoric acid.
Organic Flux—Primarily composed of organic materials other than rosin or resin, including, but not limited to, water soluble carboxylic acids, such as formic acid, acetic acid, propionic acid, malonic acid, glycolic acid, lactic acid, glyceric acid, malic acid, tartaric acid, and citric acid; water insoluble carboxylic acids, such as stearic acid, oleic acid, benzoic acid, salicylic acid, succinic acid, adipic acid, azelaic acid; optionally containing in admixture amines, amides, and hydrohalide derivatives of the amines and acids.
Rosin Flux—Primarily composed of natural resins extracted from the oleoresin of pine trees and refined, the composition may also contain additives to increase activity, such as other organic acids and amine hydrohalides. Rosin fluxes are generally not water soluble.

Additionally, the flux compositions may vary in activity as indicated by the level of halides included in the flux and by corrosion testing. Inorganic and Organic fluxes are generally water-soluble, while rosin fluxes are solvent-soluble. It is not the intention of the present invention to specify a flux type or composition, but rather to demonstrate the potential use of the variety of available fluxes.

High activity fluxes, in particular the Inorganic and Organic water-soluble types, are very effective for soldering even the most difficult metals, but may cause the formation of harmful, insoluble, corrosive residues on the soldered assembly. If allowed to remain on the substrate, the residues can result in electrical or mechanical failure of the product. In order to use a high activity flux, the present invention utilizes a second flux to render the residues from the high activity flux soluble in water, or other suitable solvent, so they can be removed from the product by washing. The second flux is a finishing flux that may or may not contain halides or other corrosive materials. If the finishing flux contains corrosives and/or halides, they must be cleanable after the reflow process. These fluxes are used in the method of the present invention with a preform of any solderable composition because they allow for versatility in depositing solder of any size or shape to the substrate.

Prior art processes to reduce the amount of residue formed on the metal after applying a deposition of solder on a base metal include using a less active flux, which can result in poor solder joints, dewetting or incomplete soldering. Another method utilizes a resist material to define the area of deposit on the metal substrate. The flux is applied and placed in the area bounded by the resist and, and then the metal substrate is dipped in molten solder or passed across a wave of solder. This method is undesirable because of the potential heat damage on the substrate and irregular solder deposit. Further, another prior art method utilizes a soldermask in an attempt to limit the spread of the solder deposit when solder paste is applied in the area defined by the soldermask. Though the solder deposit can be more uniform. The use of a soldermask would generally be expensive, time-consuming and inefficient.

The present invention comprises bonding a preformed solder deposit to a heat spreader wherein an attaching flux and finishing flux are utilized with the preform. The preform and flux may be subjected to reflow condition one or two times. Optionally, an additional amount of attach flux may be added to the solder deposit before attachment to the back side of a microprocessor die.

### SUMMARY OF THE INVENTION

The present invention is generally directed to methods of controlling solder deposition on a heat spreader or heat sink or conductive material. The methods may be utilized with electrical connections and non-electrical connections, i.e., transporting thermal energy from the device via heat sinks. The methods may also be used in forming connections for the transporting of electrical energy from one conductive metal to another metal. It will be described specifically for the controlled deposit of solder on heat spreaders or heat sinks used for semiconductor packages. The first method comprises applying a sufficient amount of an attaching flux to a heat spreader or heat sink, placing a solder preform on the flux on the heat spreader, applying a sufficient amount of finishing flux onto the preform, subjecting the heat spreader, fluxes, and preform to reflow conditions, cooling, cleaning the substrate and preform, now the solder deposit, flattening the solder deposit and optionally applying an effective amount of second attach flux to the solder depositon for attachment to a back side of a microprocessor die. An alternate method of the present invention comprises applying the attaching flux to a heat spreader or heat sink, placing a solder preform on the flux on the heat spreader, subjecting the heat spreader, attaching flux, and preform to reflow conditions, then applying a finishing flux to the heat spreader and preform, now the solder deposit, subjecting the heat spreader, solder deposit, and finishing flux to reflow conditions, cooling, cleaning the heat spreader and solder deposit, flattening the solder deposit and optionally applying a second attach flux for attachment to the back side of a microprocessor die. Another alternative method of the present invention comprises applying an attaching flux with a solder perform to a first side of a heat spreader or heat sink, following the above steps for subjecting the flux, and perform to one or two reflow conditions with the application of a finishing flux as described. Then applying an attaching flux and solder perform having a lower melting point than the first solder perform on the second side of the heat spreader and apply a finishing flux before or after subjecting the pieces to reflow conditions. The solder deposit on either side is flattened by conventional means and optionally coated with another attaching flux so the first side can be attached to the back side of a microprocessor die and the second side of the heat spreader to a heat sink.

It is the object of the present invention to provide a method of controlling solder deposition on a heat spreader.

Another object of the present invention to provide a method of using an aggressive flux with a solder without regard to the formation of harmful, insoluble, corrosive residues.

It is an object of the present invention to provide a method of predepositing a specific amount of solder metal to a heat spreader.

Other features and advantages of the present invention will become apparent to one skilled in the art upon examination of the following drawings and detailed description. It is intended that all such additional features and advantages be included herein given the scope of the present invention, as defined by the claims.

### BRIEF DESCRIPTION OF THE DRAWINGS

FIG. 1 is a flow chart of the single reflow process of the present invention;

FIG. 2 is a flow chart of the double reflow process of the present invention;

FIG. 3 shows a side elevation of the deposition of solder on a substrate,

FIG. 4 shows the flattening of the solder deposit prior to attachment to the back side of a microprocessor die, and

FIG. 5 shows the application of a solder deposit on first and second sides of a heat spreader.

### DETAILED DESCRIPTION

In accordance with the present invention, the following terms are used herein for the description of the invention.

The heat spreader or heat sink dissipates heat. It is the metal surface being soldered or the metal material on which a preform may be attached by melting the preform. The heat spreader, for example, may be copper, nickel, brass, gold, or stainless steel. The heat spreader may also be a metal or ceramic material that is plated with a solderable metal, such as copper, nickel, gold over nickel, tin-nickel, silver, or palladium.

Attaching flux is a material of sufficient activity to remove oxides and promote solder bonding on the substrate metal. The attaching flux materials may be solid, liquid, viscous paste, or tacky. The attaching flux may be mild or aggressive, depending on the tenacity of the oxidation or tarnish on the substrate surface. Aggressive attaching fluxes used for the solder bonding process could leave salt residue that is insoluble in water and most solvents. The amount and nature of the residue depends upon the chemical composition of the flux, the heat spreader, and the preform alloy used in the particular application.

A finishing flux is chosen by its compatibility with the attaching flux. A finishing flux solubilizes residues and salts from an attaching flux and allows the residues to be washed away with an appropriate solvent. The finishing flux leaves no corrosive residue or insoluble salt after washing. The finishing flux preferably will be of a viscous nature, must have sufficient activity to solubilize salts of inorganic and organic acids, but not active enough to promote additional solder spreading on the base metal or substrate.

Preform is a pre-controlled amount of solder in a defined shape or matched to a dimension of the final desired solder deposit. The ductility of the solder can be controlled by alloy selection so that a reliable interconnect is made with the two surfaces having dissimilar coefficients of thermal expansion (CTE). Solders that are useful include alloys containing tin, lead, copper, silver, zinc and indium. Tin-lead alloys, having enough lead, are sufficiently ductile to withstand the stresses generated in the joint due to the CTE mismatch between the die and the heat spreader for a reliable joint.

Solvent is any suitable liquid that will dissolve and wash away the finishing flux from the surface of the substrate and solder deposit after reflow of the preform. The solvent will be specific to the preform, flux, and substrate used. For example, the solvent may be any polar or non-polar solvent, water, alcohol, terpenes, aliphatic or aromatic petroleum hydrocarbon solvents, esters, ketones, glycol ethers, halogenated hydrocarbons, amines, etc.

Reflow is the act of heating the substrate and preform to a temperature that is greater than the liquidus of the preform. In the reflow process, preheating may be employed to evaporate the volatile solvents in the flux prior to the preform melting. The wetting ability of the flux is directly related to the peak reflow temperature. The temperature must be high enough to allow good wetting by the solder preform, but not so high as to cause excessive degradation of the flux. The reflow heat is accomplished by a combination of temperature and dwell time. The heat directly affects the activity of the flux and thus the solderability. The preheating and peak temperature and time duration are parameters to be monitored.

The method of the present invention is advantageous because it allows for a controlled deposition of solder utilizing an aggressive flux, if necessary, to assure a strong attachment of the preform to the heat spreader. Benefits of using a controlled amount of an aggressive flux include complete solder wetting of the heat spreader and elimination of voids between the solder and heat spreader. Voids are detrimental particularly in heat transfer assemblies because entrapped air and gases act as insulators, thus reducing the efficiency of heat transfer. The method uses a highly aggressive flux with no concern about a corrosive residue because the residue can be effectively removed by the application of the finishing flux and washing. The method of the present invention allows for soldering metals that are difficult to solder with mild, non-corrosive fluxes, by using an aggressive flux, followed by a finishing flux to solubilize the residues for washing away. A controlled amount or sufficient or effective amount is the amount of attaching flux that will fill the capillary space between the preform and heat spreader. If too much attaching flux is used, it will be forced out of the edges of the preform covering the flux on the heat spreader when the preform is placed thereon. Preferably a small amount of pressure is used to place the preform on the flux on the heat spreader. If too much pressure is used, some of the flux will be displaced from under the preform.

Solders used in the method of the present invention are conventional, for example, without being unduly limitative they may be tin-lead alloys, tin-silver alloys, tin-copper alloys, tin-silver-copper alloys, and 100% indium without or with tin additions. Typical amounts of metals in the alloys are as follows: (Sn 63% Pb 37%), (Sn 50% Pb 50%), (Sn 60% Pb 40%), (Sn 95% Ag 5%), (Sn 96.5%% Ag 3.5%), In 100%, (In 95.5% Sn 0.5%), (In 99.75% Sn 0.25%). The method of the present invention will function with essentially any solder that is compatible with the flux and metal heat spreader or heat sink. There is increasing interest for making electronic components lead free. Therefore, indium and several of its alloys are preferred. The thermal conductivity of indium can be enhanced by impregnation of the solder with copper, graphite, silicon carbide or diamond particles. Solder performs are precise stampings of the described solders. They can be prepared in a conventional manner. The preforms are made by alloying the solder and pouring it into a billet. The billet is compressed to extrude the solder in a wire or ribbon form. It can then be milled to the desired thickness. The ribbon can be cut or fed into a punch press and stamped to the desired dimensions.

Relating to heat spreaders, which can be any solderable metal or plating, some are easier to solder to than others. The heat spreader may be plated with a second metal to prevent corrosion such as nickel plated on copper, or to improve solderability such as palladium plated on nickel or nickel plated on aluminum. The following Table I shows a listing of metals for heat spreaders or platings in Groups 1-4 wherein the difficulty to solder increases as the number of the Group increases:

TABLE I

| Group | Heat Spreader Metals or Platings |
|---|---|
| 1 | platinum, gold, copper, tin, solder, palladium, silver |
| 2 | nickel, cadmium, brass, lead, bronze, rhodium, beryllium-copper |
| 3 | nickel-iron alloy, nickel-iron-cobalt alloy |
| 4 | zinc, mild steel, stainless steel, nickel-chrome alloy, |
| | nickel-copper alloy, aluminum |

The ease of soldering is due to the nature of the oxidation on the metal surface. Oxides on Group 1 metals can be removed with mild fluxes, such as rosin fluxes and many organic fluxes. However, metals in Group 4 have tenacious oxides that require more aggressive fluxes such as the inorganic type. The methods of the present invention can be utilized with all the foregoing metals. Nevertheless, often an easier to solder second metal may be plated on a metal surface that is more difficult to solder, for example, nickel plating on steel, gold plating on nickel, palladium plating on nickel, nickel plating on aluminum.

The following Table II shows typical attaching fluxes used in the process of the present invention on three metals that can be used in heat spreaders that are increasingly difficult to solder. The three metals are representative of the groups of metals in Table I. In Table II, the column “Fluxes” shows increased activity of the attaching fluxes listed from top to bottom, therefore, the IA or Inorganic Acid Flux has more activity and is more corrosive than type RMA or type RA rosin fluxes. The designation of fluxes is conventional and known in the industry. Preferably the listing of fluxes corresponds to the ease of soldering.

TABLE II

| Fluxes | Type | Copper | Nickel | Stainless Steel |
|---|---|---|---|---|
| Rosin, mildly activated | RMA | X | | |
| Rosin, highly activated | RA | X | X | |
| Organic acid | OA | X | X | |
| Inorganic acid | IA | X | X | X |

In Table II, “X” denotes the flux will cause the melted solder to wet the base metal of the heat spreader. Every flux type can be used with the metal substrate copper. Some more active, more aggressive, fluxes can be used on copper and nickel. The most aggressive fluxes are required for soldering stainless steel. While all fluxes identified in Table II can be used for the present invention, the most aggressive are preferred as attaching fluxes, specifically the last three in the column under “Fluxes”, Rosin highly activated (RA), organic acid (OA), and inorganic acid (IA). Some attaching fluxes, for example rosin mildly activated (RMA), may not be sufficiently active to adequately accomplish the soldering or bonding of the solder to the metal heat spreader. If this occurs, a finishing flux can be applied on top of the preform, attaching flux and heat spreader and the steps of the single reflow process are followed. The addition of the finishing flux provides for thermal insulation of the attaching flux which allows for reduction in the rate of temperature increase during reflow heating. This improves the heat stability of the attaching flux.

The foregoing fluxes may also be used as finishing fluxes, including rosin types (R), not listed above, as long as they are compatible and soluble with the specific attaching flux. Compatibility is primarily related to solubility. If the fluxes are soluble in the same solvents, they are considered compatible.

For the purpose of removing the flux residues after reflow heating of the finishing flux, the cleaning solvent may be a polar or non-polar liquid. Polar solvents include alcohols and preferably water. Non-polar solvents include, but are not limited to, aliphatic or aromatic petroleum hydrocarbon solvents, esters, ketones, glycol ethers, halogenated hydrocarbons, amines and mixtures thereof.

Representative flux formulations appear in Table III. The formulations are examples intended to enable those skilled in the art of soldering fluxes to apply the principles of this invention in practical embodiments, but are not intended to limit the scope of the invention.

TABLE III

| Flux | Type | Weight % | Chemical Name | Solubility |
|---|---|---|---|---|
| Attaching | RMA | 35 | Rosin | Non-Polar |
| Flux A | | 0.1 | Diethylamine hydrochloride | |
| | | 64.9 | 2-propanol | |
| Attaching | RA | 25 | Rosin | Non-Polar |
| Flux B | | 1 | Diethylamine Hydrochloride | |
| | | 74 | 2-propanol | |
| Attaching | OA | 11 | Glutamic Acid | Polar |
| Flux C | | | Hydrochloride | |
| | | 6 | Urea | |
| | | 82 | Water | |
| | | 1 | Ethoxylated Octylphenol | |
| Attaching | OA | 15 | Glycerine | Polar |
| Flux D | | 3 | Hydroxyacetic Acid (70%) | |
| | | 3 | Malic Acid | |
| | | 5 | Dimethylamine Hydrochloride | |
| | | 74 | 2-propanol | |
| Attaching | OA | 15 | Hydrobromic Acid (48%) | Polar |
| Flux E | | 9 | Ethanolamine | |
| | | 74 | Water | |
| | | 2 | Ethoxylated Nonylphenol | |
| Attaching | IA | 30 | Zinc Chloride | Polar |
| Flux F | | 5 | Ammonium Chloride | |
| | | 25 | Hydrochloric Acid (31%) | |
| | | 40 | Water | |
| Attaching | IA | 30 | Stannous Chloride | Polar |
| Flux G | | 10 | Zinc Chloride | |
| | | 10 | Hydrochloric Acid (31%) | |
| | | 50 | Water | |
| Attaching | IA | 60 | Orthophosphoric Acid (85%) | Polar |
| Flux H | | 39 | Water | |
| | | 1 | Ethoxylated Octylphenol | |
| Finishing | R | 30 | Rosin | Non-Polar |
| Flux 1 | | 20 | Stearic Acid | |
| | | 40 | Petrolatum | |
| | | 10 | Benzoic Acid | |
| Finishing | RMA | 35 | Rosin | Non-Polar |
| Flux 2 | | 61 | Polypropylene Glycol | |
| | | | (m.w. 2000) | |
| | | 3 | Turpentine | |
| | | 1 | Styrene Dibromide | |
| Finishing | RMA | 25 | Rosin | Polar |
| Flux 3 | | 4 | Hydrogenated Castor Oil | |
| | | 24 | Ethylene Glycol | |
| | | 3 | Malic Acid | |
| | | 39 | Ethoxylated Stearyl Alcohol | |
| | | 3 | Triethanolamine | |
| | | | Hydrochloride | |
| | | 2 | Isopropanol Amine | |
| Finishing | RA | 40 | Rosin | Non-Polar |
| Flux 4 | | 40 | Tetrahydrofurfuryl Alcohol | |
| | | 19 | 2-phenoxyethanol | |
| | | 1 | Diethylamine Hydrochloride | |
| Finishing | OA | 45 | Ethylene Glycol | Polar |
| Flux 5 | | 32 | Polyethylene Glycol | |
| | | | (m.w. 3350) | |
| | | 20 | Citric Acid | |
| | | 2 | Dimethylamine Hydrochloride | |
| | | 1 | Ethoxylated Octylphenol | |
| Finishing | OA | 7 | Ammonium Chloride | Polar |
| Flux 6 | | 3 | Hydroxyacetic Acid | |
| | | 12 | Polyethylene Glycol | |
| | | | (m.w. 3350) | |
| | | 5 | Ethoxylated Octyphenol | |
| | | 68 | Glycerine | |
| | | 5 | Behenamide | |
| Finishing | OA | 1 | Ammonium Bromide | Polar |
| Flux 7 | | 1 | Urea | |
| | | 20 | Ethoxlated Nonylphenol | |
| | | 78 | Ethanol | |
| Finishing | OA | 2 | Ammonium Bromide | Polar |
| Flux 8 | | 1 | Urea | |
| | | 25 | Ethoxylated Stearyl Alcohol | |
| | | 72 | Hexylene Glycol | |
| Finishing | IA | 30 | Orthophosphoric Acid (85%) | Polar |
| Flux 9 | | 40 | Ethoxylated Octylphenol | |
| | | 30 | Water | |
| Finishing | IA | 9 | Zinc Chloride | Polar |
| Flux 10 | | 1 | Ammonium Chloride | |
| | | 6 | Water | |
| | | 57 | Glycerine | |
| | | 18 | Polyethylene Glycol | |
| | | | (m.w. 3350) | |
| | | 5 | Ethoxylated Octylphenol | |
| | | 4 | Stearamide | |

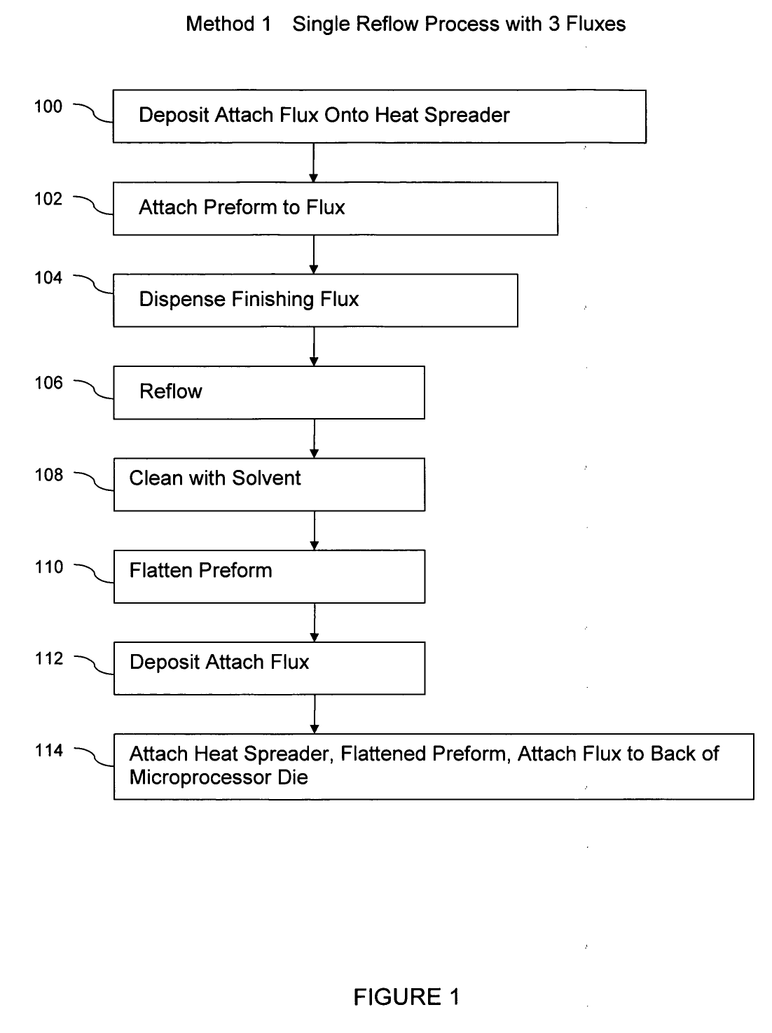

To facilitate understanding in the present invention, reference is made to FIG. 1 showing Method 1, the Single Reflow Process. A deposit of a high-activity flux or attach flux, for example, and inorganic acid flux (IA), is placed on the substrate. There are various methods for placing the flux on the heat spreader 100. The flux may be sprayed on the substrate in a controlled area and thickness, or may be coated or sprayed on the preform prior to placing the preform on the substrate metal, or a controlled deposit of the flux in a quantity sufficient to fill the capillary space between the preform and substrate may be applied. Preferably, pressure may be applied on the preform 102 as it is placed on the substrate to be soldered. If a controlled amount of the flux is deposited, there will be no excess flux on the preform or substrate, therefore none will have to be removed. If excess flux is present, it may be readily blotted or wiped clean. Typically, a small amount of the attaching flux will wet the substrate, indicating the amount of flux is sufficient.

A Finishing flux is then added in a controlled amount 104. In determining what is a controlled deposit, the amount is dependent on the activity and consistency of the flux. The sufficient or effective amount of the finishing flux in this process is an amount that will not flow underneath the preform and dilute the attaching flux. For example, the finishing fluxes, as shown in Table II as type RMA or Rosin Mildly Activated fluxes, may not be active enough to function as attaching fluxes and promote solder wetting on the substrate metal being used, but sill may have sufficient activity to solubilize the residual salts of the inorganic acid, type IA, flux being used as the aggressive attaching flux. The physical form of the finishing fluxes may be paste or a viscous gel or a liquid. The viscosity characteristics of the fluxes are unique to the flux.

The reflow process 106 allows heating by various methods known in the art: induction heating, infrared, convection oven, hot gas heating, conduction, microwave energy, etc. The temperature of the substrate being soldered is raised typically to about 20° C. to about 40° C. above the liquidus of the solder preform composition. The heating and reflow may take place in an ambient air atmosphere or under nitrogen or other inert atmosphere. The temperature and rate of heating depends upon the mass of the metal substrate and selected attaching flux. Conventional practices suggest that mild attaching fluxes such as rosin, mildly activated, are more susceptible to deterioration by high temperature and slow rate of heating. Therefore, the temperature and rate of heating should be adjusted for the selected flux type as known by skilled workers in the art. Cooling commences when the preform reaches liquidus and metal is wetted.

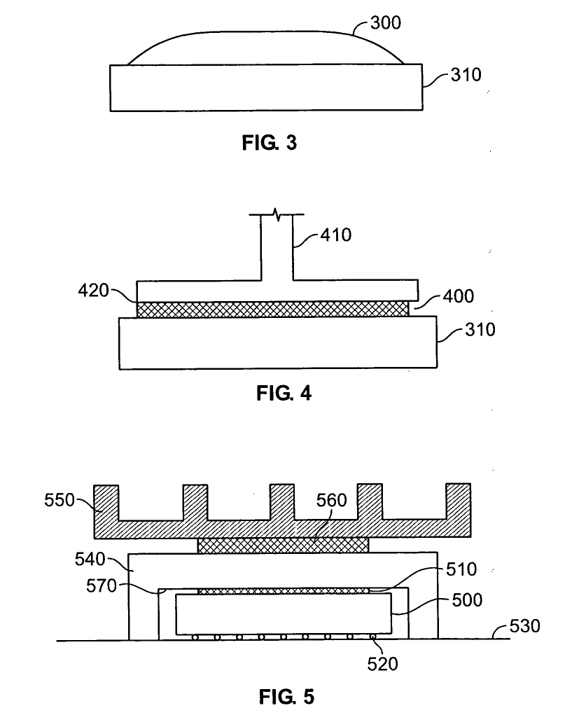

Next, the solder deposition and heat spreader are cleaned with a solvent 108, wherein the solvent may be a polar or non-polar liquid, including but not limited to isopropanol, other alcohols, water, aliphatic or aromatic petroleum hydrocarbon solvents, esters, ketones, glycol ethers, halogenated hydrocarbons, amines, and mixtures thereof. Optionally, afterwards, the finished assembly may also be dried. The solder deposit may be optionally flattened as shown in FIGS. 3 and 4. Flattening or “coining” of the solder deposit is accomplished by applying a large amount of physical pressure. This can be accomplished by conventional equipment, for example, an Arbor Press. The intent is to compress the top surface of the solder deposit to contrast the shape of the deposit. Typically, the surface topography of the solder deposit can be modified by forming channels or other designs to provide less voiding when it is attached to a die or heat sink. An attach flux 112 may optionally be applied to the solder deposit to aid in its attachment to a die or heat sink. The solder deposit with the attach flux, which preferably is Attach Flux A or B, is then attached to the back side of a microprocessor die 114. It may also be attached to a heat sink.

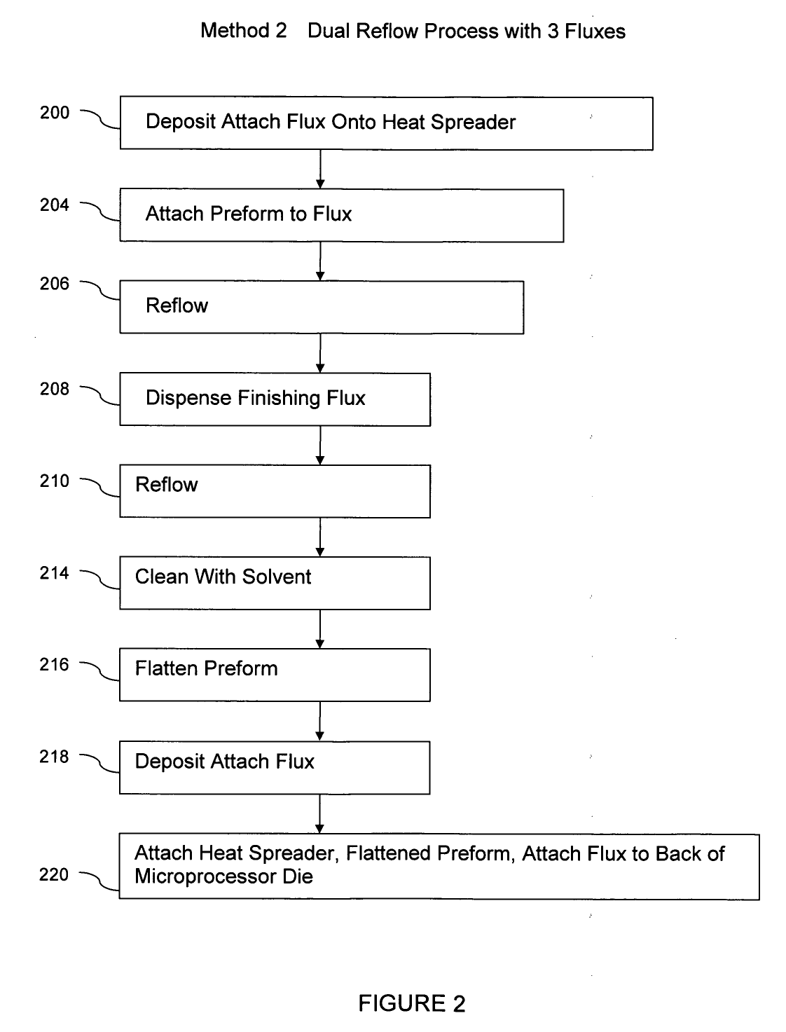

FIG. 2 shows Method 2, a Two Reflow Process. The attaching flux is deposited or placed on the heat spreader 200 as previously described and the preform is placed on the heat spreader 204. Reflow 206 then occurs under conditions previously described, but dependent on the flux, metal heat spreader and preform being used. After the soldering reflow, the finishing flux 208 is applied over the former preform which is now a solder deposit, and reflow 210 takes place again under conditions previously described. The amount of finishing flux is an amount that will cover the attaching flux and at least the edges of the solder deposit. The solder deposit and substrate are then cleaned with a polar or non-polar solvent as previously described 214 and dried. The solder deposit may be flattened 216, and covered with an attach flux 218 and attached to the back of a microprocessor die 220 as previously described.

Method I of the present invention provides an effective amount of attaching flux, which is limited to the capillary space between the substrate and preform so that even an aggressive flux can be applied and utilized in a controlled manner to provide a secure bond without concern about harmful residues. In bonding solder to metal, the method of the present invention allows for a substantial deposition of flux and solder so that the solder can be fused to provide an intermetallic bond with the base metal. The present invention allows for a controlled deposition of solder in the area. The solder may be present in amounts ranging from a thickness of about 0.005 inch to about 0.012 inch preferably, and up to 0.200 inch. The deposition of a typical amount of solder may fill an area on the base metal approximately in uniform dimensions without spreading beyond the area of deposition. After reflow on a substrate having dimensions of 1.5 inches by 1.5 inches the solder deposition after reflow would be present in an area of about 0.5 inch by 0.5 inch by 0.012 inch in a dome shape with defined boundaries.

FIG. 3 is a representation of a sufficient amount of solder 300 bonded or deposited on a heat spreader 310 after reflow. The solder is mounded and retains its position on the metal substrate.

FIG. 4 shows the deposition of solder 400 being flattened by an arm 410 on the heat spreader. The flattening of solder deposit controls its dimensions. Channeling or other marking on the top surface 420 of the solder deposit 400 provides for less voiding when the deposit is attached to a die or heat sink. The method of the present invention provides a void-free bond between the solder and the metal substrate.

FIG. 5 shows a die 500 attached to a solder preform 510. The die may be associated with various electrical devices and is made from conventional materials. It may include a microprocessor. Electrical contacts 520 may comprise solder bumps that can be coupled to a substrate 530. Substrate 530 may comprise any suitable material for carrying impulses between the die 500 and external devices.

Heat spreader 540 is coupled to heat sink 550 by solder deposit 560. In accordance with the present invention, the first side 570 of the heat spreader may preferable be coupled with a solder preform containing pure indium to the die 500. Preferable, conventional solder performs containing silver-copper-tin alloys in solder preform 560 may couple the second side of the heat spreader 580 to heat sink 550. This arrangement is not intended to be unduly limitative for other arrangements of solders may be used to contact the die and heat sink.

The following non-limiting examples are presented to further illustrate the present invention. Variations include choice of substrates, solder preform composition, attaching and finishing fluxes, reflow oven speeds, and methods for applying the fluxes. The heating method for melting the solder preform was to use a Sikama conveyorized reflow oven with the reflow zones set as follows: zone 1: 100° C., zone 2: 280° C., zone 3: 100° C., zone 4: off, zone 5: off. Each zone measures 6.25 inches in length and width, and the belt speed was varied to provide the heat required for the solder preform composition.

### EXAMPLE 1

A droplet of Attach Flux (F) of sufficient quantity to wet the surface of the solder preform is added to the nickel coated copper heat spreader. A solder preform of 100% Indium with dimensions of 0.5 inches ×0.5 inches ×0.012 inches is then placed onto the flux, and pressed down with sufficient pressure to displace any excess flux from under the preform. This excess flux was removed with a paper towel. The Finishing Flux (5) was added to the top of the preform, and around the sides of the preform with an Asymtek Century Series automatic dispensing system. The resulting product was then reflowed on a Sikama reflow oven with the reflow zones as follows: zone 1: 50° C.; zone 2: 250° C.; zone 3: 54° C.; zone 4:40° C.; zone 5: 26° C. Each zone measures 6.25 inches in length, and the belt speed was ran at 50 inches/minute. After reflow the sample was rinsed with tap water, isopropanol, and dried with forced air. The resulting product was shiny and visually free of any residues.

### EXAMPLE 2

A droplet of Attach Flux (G) of sufficient quantity to wet the surface of the solder preform is added to the nickel coated copper heat spreader. A solder preform of 100% Indium with dimensions of 0.5 inches×0.5 inches×0.012 inches is then placed onto the flux, and pressed down with sufficient pressure to displace any excess flux from under the preform. This excess flux was removed with a paper towel. The Finishing Flux (5) was added to the top of the preform, and around the sides of the preform with an Asymtek Century Series automatic dispensing system. The resulting product was then reflowed on a Sikama reflow oven with the reflow zones as follows: zone 1: off; zone 2: 280° C.; zone 3: off; zone 4: off; zone 5: off. Each zone measures 6.25 inches in length, and the belt speed was ran at 60 inches/minute. After reflow the sample was rinsed with tap water, isopropanol, and dried with forced air. The resulting product was shiny and visually free of any residues.

### EXAMPLE 3

A droplet of Attach Flux (with same formula as in Example 1) of sufficient quantity to wet the surface of the solder preform is added to the gold coated nickel/copper heat spreader. A solder preform of 100% Indium with dimensions of 0.5 inches×0.5 inches ×0.012 inches is then placed onto the flux, and pressed down with sufficient pressure to displace any excess flux from under the preform. This excess flux was removed with a paper towel. The Finishing Flux (with same formula as in Example 1) was added to the top of the preform, and around the sides of the preform with an Asymtek Century Series automatic dispensing system. The resulting product was then reflowed on a Sikama reflow oven with the reflow zones as follows: zone 1: off; zone 2: 280° C.; zone 3: off; zone 4: off; zone 5: off. Each zone measures 6.25 inches in length, and the belt speed was ran at 60 inches/minute. After reflow the sample was rinsed with tap water, isopropanol, and dried with forced air. The resulting product was shiny and visually free of any residues.

### EXAMPLE 4

A droplet of Attach Flux (with same formula as Example 1) of sufficient quantity to wet the surface of the solder preform is added to the nickel coated copper heat spreader. A solder preform of 100% Indium with dimensions of 0.5 inches×0.5 inches×0.012 inches is then placed onto the flux, and pressed down with sufficient pressure to displace any excess flux from under the preform. This excess flux was removed with a paper towel. The resulting product was then reflowed on a Sikama reflow oven with the reflow zones as follows: zone 1: off; zone 2: 280° C.; zone 3: off; zone 4: off; zone 5: off. Each zone measures 6.25 inches in length, and the belt speed was ran at 60 inches/minute. The Finishing Flux (with same formula as Example 1) was added copiously by hand to the top of the preform, and around the sides of the preform and reflowed again with the same conditions mentioned previously. After the second reflow the sample was rinsed with tap water, isopropanol, and dried with forced air. The resulting product was shiny and visually free of any residues.

### EXAMPLE 5

A droplet of Attach Flux (with same formula as Example 1) of sufficient quantity to wet the surface of the solder preform is added to the nickel coated copper heat spreader. A solder preform of 0.5% Tin/95.5% Indium with dimensions of 0.5 inches×0.5 inches×0.012 inches is then placed onto the flux, and pressed down with sufficient pressure to displace any excess flux from under the preform. This excess flux was removed with a paper towel. The resulting product was then reflowed on a Sikama reflow oven with the reflow zones as follows: zone 1: off; zone 2: 280° C.; zone 3: off; zone 4: off; zone 5: off. Each zone measures 6.25 inches in length, and the belt speed was ran at 50 inches/minute. The Finishing Flux (with same formula as Example 1) was added copiously by hand to the top of the preform, and around the sides of the preform and reflowed again with the same conditions mentioned previously. After the second reflow the sample was rinsed with tap water, isopropanol, and dried with forced air. The resulting product was visually free of any residues.

### EXAMPLE 6

A droplet of Attach Flux (with same formula as Example 1) of sufficient quantity to wet the surface of the solder preform is added to the nickel coated copper heat spreader. A solder preform of 63% Tin/37% Lead with dimensions of 0.6 inches×0.6 inches×0.012 inches is then placed onto the flux, and pressed down with sufficient pressure to displace any excess flux from under the preform. This excess flux was removed with a paper towel. The resulting product was then reflowed on a Sikama reflow oven with the reflow zones as follows: zone 1: off; zone 2: 280° C.; zone 3: off; zone 4: off; zone 5: off. Each zone measures 6.25 inches in length, and the belt speed was ran at 50 inches/minute. The Finishing Flux (with same formula as Example 1) was added copiously by hand to the top of the preform, and around the sides of the preform and reflowed again with the same conditions mentioned previously. After the second reflow the sample was rinsed with tap water, isopropanol, and dried with forced air. The resulting product was visually free of any residues.

### EXAMPLE 7

A droplet of Attach Flux (with same formula as Example 1) of sufficient quantity to wet the surface of the solder preform is added to the nickel coated copper heat spreader. A solder preform of 97% Indium/3% Silver with dimensions of 0.5 inches×0.5 inches×0.012 inches is then placed onto the flux, and pressed down with sufficient pressure to displace any excess flux from under the preform. This excess flux was removed with a paper towel. The resulting product was then reflowed on a Sikama reflow oven with the reflow zones as follows: zone 1: off; zone 2: 280° C.; zone 3: off; zone 4: off; zone 5: off. Each zone measures 6.25 inches in length, and the belt speed was ran at 50 inches/minute. The Finishing Flux (with same formula as Example 1) was added copiously by hand to the top of the preform, and around the sides of the preform and reflowed again with the same conditions mentioned previously. After the second reflow the sample was rinsed with tap water, isopropanol, and dried with forced air. The resulting product was visually free of any residues.

### EXAMPLE 8

A droplet of Attach Flux (with same formula as Example 1) of sufficient quantity to wet the surface of the solder preform is added to the nickel coated copper heat spreader. A solder preform of 63% Tin/37% Lead with dimensions of 0.6 inches×0.6 inches×0.012 inches is then placed onto the flux, and pressed down with sufficient pressure to displace any excess flux from under the preform. This excess flux was removed with a paper towel. The resulting product was then reflowed on a Sikama reflow oven with the reflow zones as follows: zone 1: off; zone 2: 280° C.; zone 3: off; zone 4: off; zone 5: off. Each zone measures 6.25 inches in length, and the belt speed was ran at 50 inches/minute. The Finishing Flux (5) was added copiously by hand to the top of the preform, and around the sides of the preform and reflowed again with the same conditions mentioned previously. After the second reflow the sample was rinsed with tap water, isopropanol, and dried with forced air. The resulting product was visually free of any residues.

While the present invention has been particularly described, in conjunction with the specific preferred embodiment, it is evident that many alternatives, modifications, and variations will be apparent to those skilled in the art in light of the foregoing description. It is therefore contemplated that the appended claims will embrace any such alternatives, modifications, and variations as falling within the truth, scope, and spirit of the present invention.

### EXAMPLE 9

A droplet of Attach Flux (with the same formula as Example 1) of sufficient quantity to wet the surface of the solder perform is added to the nickel coated copper heat spreader. A solder preform of 100% Indium with dimensions of 0.5 inches×0.5 inches×0.012 inches is then placed onto the flux, and pressed down with sufficient pressure to displace any excess flux from under the perform. The excess flux was removed with a paper towel. The resulting product was then reflowed on a Sikama reflow oven with the reflow zones as follows: zone 1: off; zone 2: 289 C; zone 3: off; zone 4: off; zone 5: off. Each zone measures 6.25 inches in length, and the belt speed was ran at 60 inches/minute. The Finishing Flux (with the same formula as Example 1) was added copiously by hand to the top of the preform, and around the sides of the preform and reflowed again with the same conditions mentioned previously. After the second reflow the sample was rinsed with tap water, isopropanol, and dried with forced air. The resulting product was shiny and visually free of any residues. The resulting assembly was placed in a die press, which was then placed in a hydraulic press to flatten or coin the indium deposit. The coin deposit was then coated with a low activity Attach Flux A and was readily available for coupling with the back of a microprocessor die.

### EXAMPLE 10

A droplet of Attach Flux F of sufficient quantity to wet the surface of a solder perform is added to a first side of the nickel coated copper heat spreader. A solder perform of 95.5% tin, 3.75% silver, 0.75% copper with dimensions of 0.5 inches by 0.5 inches by 0.012 inches is then placed onto the flux, and pressed down with sufficient pressure to displace any excess flux from under the preform. The excess flux was removed with a paper towel. The resulting product was then reflowed on a Sikama reflow oven with reflow zones as follows: zone 1: 70° C.; zone 2: 100° C.; zone 3: 176° C.; zone 4: 250° C.; zone 5: 500° C. Each zone measures 6.25 inches in length and the belt speed was run at 50 inches/minute. The Finishing Flux 5 was added copiously by hand to the top of the preform, and around the sides of the perform and reflowed again with the same conductors mentioned previously. After the second reflow the sample was rinsed with tap water, isopropanol and dried with forced air. The resulting product was free of residues. This first surface of the heat spreader can be attached to a heat sink.

To the second side of the heat spreader, a drop of Attach Flux F of sufficient quantity to wet the surface of the solder perform is added to the nickel coated copper heat spreader. A solder perform of 100% indium with dimensions of 0.5 inches by 0.5 inches by 0.612 inches is then placed onto the flux, pressed down with sufficient pressure to displace any excess flux from under the perform. The excess flux was removed with a paper towel. The Finishing Flux 5 was added to the indium perform on the top and sides. The resulting product was then reflowed on a Sikama reflow oven with the reflow zones as follows: zone 1: off; zone 2: 280° C.; zone 3: off; zone 4: off; zone 5: off. Each zone measures 6.25 inches in length and the belt speed was run at 60 inches/minute. After reflow the sample was rinsed with tap water, isopropanol and dried with forced air. The resulting product was shiny and visually free of any residues. The second side of the heat spreader can be attached to the back of a microprocessor die.

The respective solder deposits on the first and second sides of the heat spreader were individually flattened and channeled to increase the surface topography for less voiding when they are attached to a die or heat sink, respectively.

A predeposition flux, Attach Flux A, a low activity flux, was added to each solder deposit on the first and second sides of the heat spreader to aid in the attachment of the first side to a heat sink and the second side to the backside of a microprocessor die.

While the present invention has been particularly described, in conjunction with the specific preferred embodiment, it is evident that many alternatives, modifications, and variations will be apparent to those skilled in the art in light of the foregoing description. It is therefore contemplated that the appended claims will embrace any such alternatives, modifications, and variations as falling within the truth, scope, and spirit of the present invention.

We claim:

1. A method of controlling solder deposition on a heat spreader and preformed solder comprising:
a) applying an effective amount of an attaching flux to a heat spreader,
b) placing a preform on the heat spreader containing an effective amount of the attaching flux,
c) applying an effective amount of a finishing flux onto the preform,
d) subjecting the heat spreader, solder, flux and preform to heated reflow conditions, to form a solder deposit,
e) cleaning the heat spreader and solder deposit, and
f) flattening the preform.

2. The method of claim 1 wherein the attaching flux may cause the formation of harmful, insoluble, or corrosive residues on the soldered heat spreader if it is allowed to remain on the soldered heat spreader.

3. The method of claim 1 wherein the amount of attaching flux is sufficient to fill a capillary space between the preform and heat spreader.

4. The method of claim 1 wherein the attaching flux is rosin mildly activated type.

5. The method of claim 1 wherein the attaching flux is rosin highly activated type.

6. The method of claim 1 wherein the attaching flux is an organic acid type.

7. The method of claim 1 wherein the attaching flux is an inorganic acid type.

8. The method of claim 1 wherein the preform is placed on the heat spreader with sufficient force to have it contact the attaching flux on the heat spreader.

9. The method of claim 1 wherein the finishing flux is selected from the group consisting of rosin, rosin mildly activated, rosin activated, organic and inorganic acid fluxes.

10. The method of claim 1 wherein the amount of finishing flux is sufficient to solubilize salts of the attaching fluxes on the heat spreader after reflow.

11. The method of claim 1 wherein the reflow conditions cause the solder preform to be liquidus and to wet the heat spreader.

12. The method of claim 11 wherein the reflow conditions comprise heating the preform and heat spreader at about 20 to about 40° C. above the liquidus of the solder.

13. The method of claim 1 wherein the heat spreader and solder deposit are cleaned by washing with suitable solvents.

14. The method of claim 1 wherein the heat spreader and solder deposit are cleaned by solvents selected from the group consisting of polar solvents and non-polar solvents.

15. The method of claim 1 wherein the solder is selected from the group consisting of indium, indium alloys, silver-copper-tin alloys and tin-lead alloys

16. The method of claim 15 wherein the solder is indium.

17. The method of claim 1 wherein the solder deposit is free of voids.

18. The method of claim 4 wherein the heat spreader is selected from the group consisting of platinum, gold, copper, tin, solder, palladium and silver.

19. The method of claim 1 wherein the flattened solder deposit is covered with an attach flux.

20. The method of claim 1 wherein the heat spreader, flattened solder deposit and finishing flux are attached to the back of a microprocessor die.

21. The method of claim 18 wherein the heat spreader is copper.

22. The method of claim 18 wherein the heat spreader surface is plated with a second metal.

23. The method of claim 5 wherein the heat spreader is selected from the group consisting of nickel, cadmium, brass, lead, bronze, rhodium, copper, and beryllium-copper.

24. The method of claim 23 wherein the substrate is copper.

25. The method of claim 23 wherein the substrate is nickel.

26. The method of claim 23 wherein the heat spreader is plated with a second metal.

27. The method of claim 6 wherein the heat spreader is selected from the group consisting of nickel-iron, nickel-iron-cobalt, copper and nickel.

28. The method of claim 27 wherein the heat spreader is plated with a second metal.

29. The method of claim 27 wherein the heat spreader is copper.

30. The method of claim 27 wherein the heat spreader is nickel.

31. The method of claim 7 wherein the heat spreader is selected from the group consisting of copper, nickel, zinc, mild steel, stainless steel, nickel-chrome, nickel-copper and aluminum.

32. The method of claim 31 wherein the substrate is copper.

33. The method of claim 31 wherein the substrate is nickel.

34. The method of claim 31 wherein the substrate is stainless steel.

35. The method of claim 31 wherein the substrate is mild steel.

36. The method of claim 31 wherein the substrate is plated with a second metal.

37. The method of claim 1 wherein the heat spreader and solder deposit are cleaned by solvents selected from the group consisting of polar solvents and non-polar solvents.

38. The method of controlling solder deposition on a heat spreader and preformed solder comprising:
a) applying an effective amount of an attaching flux to a heat spreader,
b) placing a preform on the heat spreader containing an effective amount of the attaching flux,
c) subjecting the heat spreader, flux and preform to heated reflow conditions, forming a solder deposit,
d) applying an effective amount of a finishing flux to the solder deposit to solubilize residues left by the attaching flux,
e) subjecting the heat spreader, finishing flux and solder deposit to heated reflow conditions,
f) cleaning the heat spreader and solder deposit, and
g) flattening the preform.

39. The method of claim 38 wherein the attaching flux may cause the formation of harmful, insoluble, or corrosive residues on the solder deposit and heat spreader if it is allowed to remain on the solder deposit and heat spreader.

40. The method of claim 38 wherein the amount of attaching flux is sufficient to fill a capillary space between the preform and heat spreader.

41. The method of claim 38 wherein the attaching flux is rosin mildly activated type.

42. The method of claim 38 wherein the attaching flux is rosin highly activated type.

43. The method of claim 38 wherein the attaching flux is an organic acid type.

44. The method of claim 38 wherein the attaching flux is an inorganic acid type.

45. The method of claim 38 wherein the heat spreader is selected from the group consisting of platinum, gold, copper, tin, solder, palladium and silver.

46. The method of claim 38 wherein the heat spreader and solder deposit are cleaned by washing with suitable solvents.

47. The method of claim 45 wherein the substrate is copper.

48. The method of claim 38 where the heat spreader and solder deposit are cleaned by solvents selected from the group consisting of polar solvents and non-polar solvents.

49. The method of claim 38 wherein the heat spreader is plated with a second metal.

50. The method of claim 38 wherein the solder is selected from the group consisting of indium, indium alloys, silver-copper-tin alloys, and tin-lead alloys.

51. The method of claim 38 wherein the heat spreader is selected from the group consisting of nickel, copper, cadmium, brass, lead, bronze, rhodium, beryllium-copper.

52. The method of claim 50 wherein the solder is indium.

53. The method of claim 51 wherein the heat spreader is copper.

54. The method of claim 51 wherein the heat spreader is nickel.

55. The method of claim 51 wherein the heat spreader is plated with a second metal.

56. The method of claim 38 wherein the heat spreader is selected from the group consisting of nickel-iron, nickel-iron-cobalt, copper and nickel.

57. The method of claim 56 wherein the heat spreader is plated with a second metal.

58. The method of claim 56 wherein the heat spreader is copper.

59. The method of claim 56 wherein the heat spreader is nickel.

60. The method of claim 38 wherein the heat spreader is selected from the group consisting of copper, nickel, zinc, mild steel, stainless steel, nickel-chrome, nickel-copper and aluminum.

61. The method of claim 60 wherein the heat spreader is copper.

62. The method of claim 60 wherein the heat spreader is nickel.

63. The method of claim 60 wherein the heat spreader is stainless steel.

64. The method of claim 55 wherein the heat spreader is mild steel.

65. The method of claim 55 wherein the heat spreader is plated with a second metal.

66. The method of claim 38 wherein the reflow conditions cause the solder preform to be liquidus and to wet the heat spreader.

67. The method of claim 38 wherein the reflow conditions comprise heating the preform and heat spreader at about 20-40° C., above the liquidus of the solder.

68. The method of claim 38 wherein the heat spreader and solder deposit are cleaned by washing with suitable solvents.

69. The method of claim 38 wherein the heat spreader and solder deposit are cleaned by solvents selected from the group consisting of polar solvents and non-polar solvents.

70. The method of claim 38 wherein the finishing flux is selected from the group consisting of rosin, rosin mildly activated, rosin activated, organic and inorganic fluxes.

71. The method of claim 38 wherein the solder deposit is free of voids.

72. The method of claim 38 wherein the flattened solder deposit is covered with a attach flux.

73. The method of claim 38 wherein the flattened heat spreader, perform, and finishing flux are attached to the back of a microprocessor die.

74. The method of controlling solder deposition on a heat spreader and preformed solder comprising:
a) applying an effective amount of an attaching flux to a first side of a heat spreader,
b) placing a preform on the heat spreader containing an effective amount of the attaching flux,
c) subjecting the heat spreader, flux and preform to heated reflow conditions, forming a solder deposit,
d) applying an effective amount of a finishing flux to the solder deposit to solubilize residues left by the attaching flux,
e) subjecting the heat spreader, finishing flux and solder deposit to heated reflow conditions,
f) cleaning the heat spreader and solder deposit,
g) flattening the preform,
h) applying an effective amount of an attaching flux to a second side of a heat spreader,
i) placing a preform on the heat spreader containing an effective amount of the attaching flux,
j) subjecting the heat spreader, flux and preform to heated reflow conditions, forming a solder deposit,
k) applying an effective amount of a finishing flux to the solder deposit to solubilize residues left by the attaching flux,
l) subjecting the heat spreader, finishing flux and solder deposit to heated reflow conditions,
m) cleaning the heat spreader and solder deposit, and
n) flattening the preform.

75. The method of claim 74 wherein the first side of the heat spreader is attached to a heat sink or die.

76. The method of claim 74 wherein the second side of the heat spreader is attached to a heat sink or die.

77. The method of claim 74 wherein an attach flux is predeposited on the flattened preform before attachment to a heat sink or die.

78. A method of controlling solder deposition on a heat spreader and preformed solder comprising:
a) applying an effective amount of an attaching flux to a first side of a heat spreader,
b) placing a perform on the heat spreader containing an effective amount of the attaching flux,
c) applying an effective amount of a finishing flux onto the perform,
d) subjecting the heat spreader, solder, flux and perform to heated reflow conditions to form a solder deposit,
e) cleaning the heat spreader and solder deposit, and
f) flattening the preform,
g) applying an effective amount of an attaching flux to a second side of a heat spreader,
h) placing a preform on the heat spreader containing an effective amount of the attaching flux,
i) applying an effective amount of a finishing flux onto the preform,
j) subjecting the heat spreader, solder, flux and preform to heated reflow conditions to form a solder deposit,
k) cleaning the heat spreader and solder deposit, and
h) flattening the preform.

79. The method of claim 78 wherein the first side of the heat spreader is attached to a heat sink or die.

80. The method of claim 78 wherein the second side of the heat spreader is attached to a heat sink or die.

81. The method of claim 78 wherein an attach flux is predeposited on the flattened preform.
